(19) United States
(12) Patent Application Publication
(10) Pub. No.: US 2021/0221058 A1
(43) Pub. Date: Jul. 22, 2021

(54) PRINTER COOLING

(71) Applicants: Emilio Carlos CANO, Barcelona (ES); Ignacio ALEJANDRE, Barcelona (ES); Oriol BORRELL CARBONELL, Barcelona (ES); Pamela Carolina ZALDUMBIDE SALAVERRIA, Barcelona (ES); Oriol ROIG, Barcelona (ES); HEWLETT-PACKARD DEVELOPMENT COMPANY, L.P., Houston, TX (US)

(72) Inventors: Emilio Carlos Cano, Sant Cugat del Valles (ES); Ignacio Alejandre, Sant Cugat del Valles (ES); Oriol Borrell Carbonell, Sant Cugat del Valles (ES); Pamela Carolina Zaldumbide Salaverria, Sant Cugat del Valles (ES); Oriol Roig, Sant Cugat del Valles (ES)

(73) Assignee: HEWLETT-PACKARD DEVELOPMENT COMPANY, L.P., Houston, TX (US)

(21) Appl. No.: 16/095,781

(22) PCT Filed: Jul. 1, 2016
(86) PCT No.: PCT/EP2016/065618

§ 371 Date: Oct. 23, 2018

(51) Int. Cl. B29C 64/25; B29C 64/264; B33Y 30/00; B33Y 10/00

(52) U.S. Cl. CPC B29C 64/25; B33Y 10/00; B33Y 30/00; B29C 64/264

(57) ABSTRACT

Certain examples described herein relate to printer (110, 210) cooling systems of three-dimensional (3D) printers. In an example of a printer (110, 210) cooling system of a three-dimensional (3D) printer (110, 210), a shared air flow volume (120, 220) is for cooling a plurality of internal printer components (130, 140, 230, 240), and a single air inlet (150, 245) delivers ambient air (160) from outside the three-dimensional (3D) printer (110, 210) to the shared air flow volume (120, 220) In certain cases, the shared air flow volume (120, 220) comprises a first air flow conduit (135, 270) for cooling a first internal printer component (130, 230) and a second air flow conduit (145, 275) for cooling a second internal printer component (140, 240). In certain examples, the first and the second air flow conduits (135, 270) are arranged at least partially in parallel.

### BACKGROUND

Many printing systems include elements which, when the printing system is in operation, become hot. Such printing systems include additive manufacturing systems, commonly referred to as “3D printers”, which may use, for example, high power heating elements for curing and fusion processes. Hot elements may not function properly without being cooled.

### BRIEF DESCRIPTION OF THE DRAWINGS

Various features of the present disclosure will be apparent from the detailed description which follows, taken in conjunction with the accompanying drawings, which together illustrate, by way of example only, features of the present disclosure, and wherein:

FIG. 1 is a schematic illustration showing a printer cooling apparatus according to an example;

FIG. 2 is a schematic illustration showing a printer cooling apparatus according to an example;

FIG. 3 is a flow diagram showing a method of operating a printer cooling system according to an example;

FIG. 4 is a flow diagram showing a method of operating a printer cooling system according to an example; and

FIG. 5 is a schematic illustration showing a processor and a computer readable storage medium with instructions stored thereon according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

Certain examples described herein enable reduction of the frequency of maintenance operations performed on a printer. Such maintenance operations may involve printer downtime and/or human intervention. Certain examples additionally or alternatively enable reduction in the complexity of such maintenance operations. The extent of printer downtime associated with such maintenance operations may thereby be reduced, thus improving the productivity rate of the printer.

Certain examples provide an efficient cooling system for cooling a plurality of printer subsystems using a common supply of relatively clean air. Such printer subsystems may operate more effectively if supplied with cool, clean air. Relatively clean air may be ambient air that is filtered to remove particulates of dust, powder, printing materials, etc. In powder-based three-dimensional (3D) printing systems, at least some printer subsystems may be situated in internal printer volumes which may, during operation, contain a suspension of powder and/or printing materials in air. At least some printer subsystems may operate more effectively if they are exposed to relatively clean air instead of air containing particulates such as those described above.

Certain examples provide a cooling system with a relatively low degree of complexity. A single air inlet comprising a filter may be used to deliver air to the cooling system to cool a plurality of printer subsystems. In some examples, a single air outlet comprising a filter is used to deliver air from the cooling system. Consequently, a relatively small number of filters (e.g. one or two) may be used to enable the supply of clean air to a relatively larger number of printer subsystems (e.g. six or ten). The filters that are used may be placed in user-accessible locations, for example at a single inlet and single outlet. Consequently, maintenance operations relating to the filters may be performed faster and/or with greater ease. In addition to a relatively small number of filters, a relatively small number of filter holders, filter sensors and/or associated sensor electronics may be used in conjunction with such a cooling system. Accordingly, such a cooling system may be associated with relatively few possible failure modes, thereby simplifying fault detection and management. The probability of an occurrence of an unexpected failure mode may also be reduced in such a low-complexity cooling system.

Certain examples provide a printer cooling system which cools a plurality of internal printer subsystems using a shared supply of filtered ambient air without refrigeration of the air. Such a cooling system may be more reliable, less expensive and less complex than a refrigeration-based cooling system.

Certain examples reduce the probability of heat damage to printer elements that are exposed to high temperatures. In addition to heat-generating elements themselves, temperature-sensitive elements that are downstream and/or in the vicinity of heat-generating elements may also be protected from damage. Temperature-sensitive printer elements may therefore be positioned downstream and/or in the vicinity of heat-generating printer elements with a reduced probability of heat damage. Accordingly, both heat-generating and temperature-sensitive printer elements may acquire an improved functionality and/or longevity, as they may be able to operate for a longer time period without replacement or servicing. Such printer elements may also acquire an improved level of performance where a level of performance for a given printer element is related to the operating temperature of the given printer element.

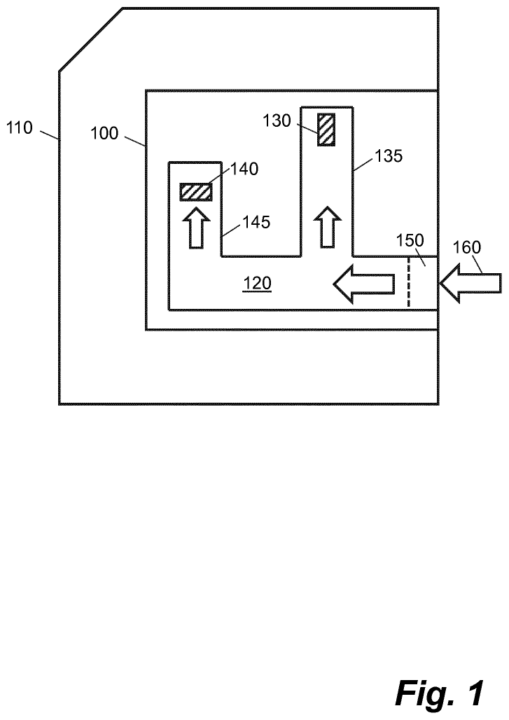

FIG. 1 shows a printer cooling apparatus 100 according to an example. The printer cooling apparatus 100 is incorporated at least in part in a three-dimensional (3D) printer 110. The 3D printer 110 may, for example, comprise a printing agent and powder-based additive manufacturing system. The 3D printer 110 comprises a plurality of internal printer components 130, 140. The printer cooling apparatus 100 may comprise further components, however these are omitted in the present description for ease of explanation.

The printer cooling apparatus 100 comprises a shared air flow volume 120. The shared air flow volume 120 may comprise at least one air flow channel. The shared air flow volume 120 may be arranged within the 3D printer 110. In some examples, the shared air flow volume 120 is at least partially arranged outside the 3D printer 110.

The shared air flow volume 120 cools a plurality of internal printer components 130, 140. The shared air flow volume 120 comprises a first air flow conduit 135 for cooling a first internal printer component 130 and a second air flow conduit 145 for cooling a second internal printer component 140. The first and the second air flow conduits 135, 145 are arranged at least partially in parallel. The internal printer components 130, 140 may be components which, when the 3D printer 110 is in operation, become hot. In some examples, the internal printer components 130, 140 are relatively hot compared with ambient air from outside the 3D printer. Ambient air from outside the 3D printer may, for example, have a temperature in the range of 280-300K. The internal printer components 130, 140 and/or the air surrounding the internal printer components 130, 140 may, for example, have a temperature in the range of 400-600K. In some examples, at least one of the plurality of internal printer components 130, 140 generates heat during operation of the 3D printer 110. In some examples, at least one of the plurality of internal printer components 130, 140 is exposed to heat from its environment. The internal printer components 130, 140 may be cooled by an air flow. The air for cooling the internal printer components 130, 140 may be conveyed by the shared air flow volume 120. The internal printer components 130, 140 may not function correctly if they are not able to be cooled sufficiently. In some examples, the internal printer components 130, 140 may not function within predetermined performance parameters if they do not receive a sufficient flow of relatively clean air. An example of relatively clean air is ambient air from outside the 3D printing system 110. A further example of relatively clean air is ambient air from outside the 3D printing system 110 that has passed through a filter. The plurality of internal printer components 130, 140 may comprise more than two internal printer components. In some examples, the plurality of internal printer components 130, 140 comprises six internal printer components. Examples of internal printer components 130, 140 include, but are not limited to, fusing lamps, curing lamps, carriages, print heads, blowing stations and service stations.

The printer cooling apparatus 100 comprises a single air inlet 150. The single air inlet 150 delivers ambient air 160 from outside the 3D printer 110 to the shared air flow volume 120. The air delivered to the shared air flow volume 120 via the single air inlet 150 enables the shared air flow volume 120 to cool the plurality of internal printer components 130, 140. In some examples, the shared air flow volume 120 cools the plurality of internal printer components 130, 140 on account of the ambient air 160 from outside the 3D printer 110 being relatively cool compared with the temperature of the internal printer components 130, 140 when the 3D printer 110 is in operation. In some examples, the shared air flow volume 120 cools the plurality of internal printer components 130, 140 by cooling the air surrounding the internal printer components 130, 140. The single air inlet 150 may be arranged on the surface of the body of the 3D printer 110. In some examples, the single air inlet 150 is arranged within the 3D printer 110. In other examples, the single air inlet 150 is arranged externally relative to the 3D printer 110. For example, the single air inlet 150 may be arranged as part of a hose or pipe extending outside the body of the 3D printer 110.

The single air inlet 150 may comprise at least one inlet chamber. In some examples, the single air inlet 150 comprises at least one filter. The at least one filter may be arranged within the at least one inlet chamber. In some examples, the single air inlet 150 comprises a single common filter. The at least one filter may filter the ambient air 160 that is delivered to the shared air flow volume 120. The shared air flow volume 120 may therefore be considered to be a centralized volume of cool and clean air. The single air inlet 150 may comprise at least one filter holder to hold the at least one filter. In some examples, the single air inlet 150 comprises at least one filter sensor to sense when the at least one filter is to be changed. The at least one filter sensor may cause a maintenance operation to be initiated to change the at least one filter. The single air inlet 150 may be associated with at least one inlet fan. When in operation, the at least one inlet fan may draw air from outside the 3D printer 110 through the single air inlet 150 and into the shared air flow volume 120. The at least one inlet fan may be controlled by control software. Such control software may be arranged within a computer control system. The computer control system may comprise a processor and a memory. The computer control system may be arranged within the 3D printer 110 or within the printer cooling apparatus 100.

When in operation, ambient air 160 is drawn through the single air inlet 150 and into the shared air flow volume 120. The air in the shared air flow volume 120 is used to cool the plurality of internal printer components 130, 140.

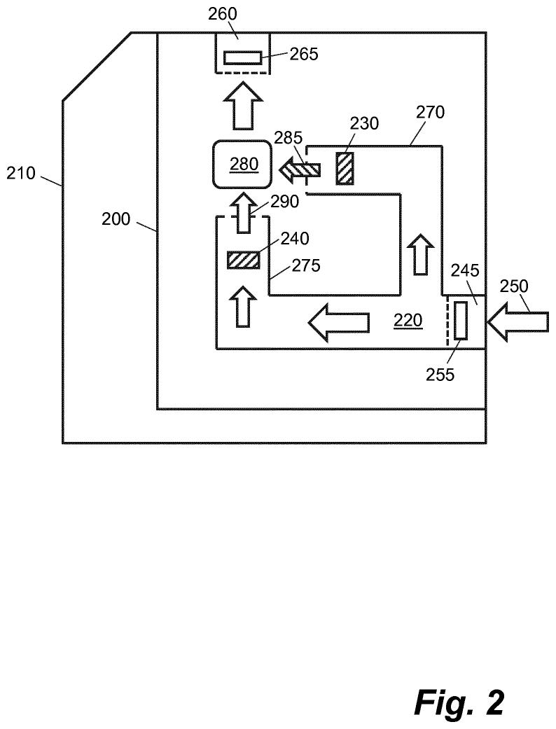

FIG. 2 shows a printer cooling apparatus 200 according to an example. The printer cooling apparatus 200 is incorporated at least in part in a 3D printer 210. The 3D printer 210 is similar to that shown in FIG. 1 and comprises a plurality of internal printer components 230, 240. The printer cooling apparatus 200 comprises a shared air flow volume 220 for cooling the plurality of internal printer components 230, 240. The printer cooling apparatus 200 comprises a single air inlet 245 to deliver ambient air 250 from the surroundings of the 3D printer 210 to the shared air flow volume 220. The single air inlet 245 may be associated with an inlet fan. In some examples, the printer cooling apparatus 200 comprises a pressure sensor to determine an air pressure of the shared air flow volume 220. The single air inlet 245 may deliver ambient air 250 from outside the 3D printer 210 to the shared air flow volume 220 based on the determined air pressure of the shared air flow volume 220.

In the present example, the printer cooling apparatus 200 comprises a filter 255. The filter 255 may be associated with the single air inlet 245. The filter 255 filters the ambient air 250 that is delivered to the shared air flow volume 220 by the single air inlet 245. The air that is delivered to the shared air flow volume 220 for cooling the plurality of internal printer components 230, 240 may therefore be considered to be relatively clean. The filter 255 may comprise a particulate air filter. For example, the filter 255 may comprise a porous material. Examples of such porous materials include, but are not limited to, cottons, fiberglass, papers and foams. A particulate air filter may be capable of removing solid particulates such as dust, powder, printing materials or bacteria from air that passes through the filter. In some examples, the filter 255 is a chemical air filter. For example, the filter 255 may comprise a chemically absorbent material. Filtering the air prior to ingress to the shared air flow volume 220 may protect at least some of the plurality of internal printer components 230, 240 from particles of dust, powder, dirt, printing material, etc. In some examples, filtering the air prior to ingress to the shared air flow volume 220 allows relatively clean air to enter the shared air flow volume 220 and prevents relatively dirty air from entering the shared air flow volume 220. At least some of the plurality of internal printer components 230, 240 may operate more effectively in the absence of such particles.

The shared air flow volume 220 may comprise a plurality of air flow conduits. In the present example, the shared air flow volume 220 comprises a first air flow conduit 270 and a second air flow conduit 275. Each of the first air flow conduit 270 and the second air flow conduit 275 may comprise at least one pipe or tube. The first air flow conduit 270 delivers air to cool at least a first internal printer component 230 of the plurality of internal printer components 230, 240. The second air flow conduit 275 delivers air to cool at least a second internal printer component 240 of the plurality of internal printer components 230, 240. In the present example, the first air flow conduit 270 and the second air flow conduit 275 are arranged at least partially in parallel. In other words, at least a portion of the first air flow conduit 270 and at least a portion of the second air flow conduit 275 may be arranged in parallel. In some examples, at least one of the first air flow conduit 270 and the second air flow conduit 275 is arranged entirely in parallel with at least a portion of the other of the first air flow conduit 270 and the second air flow conduit 275. In some examples, the first air flow conduit 270 and the second air flow conduit 275 are both arranged entirely in parallel. In other words, the first air flow conduit 270 and the second air flow conduit 275 may be considered to be different branches of the shared air flow volume 220. Air may flow through the first air flow conduit 270 and/or the second air flow conduit 275. In some examples, the first air flow conduit 270 and the second air flow conduit 275 are not part of the shared air flow volume 220 but are each coupled to the shared air flow volume 220 such that each of the first and the second air flow conduits 270, 275 have access to the air within the shared air flow volume 220. In some examples, the first air flow conduit 270 and the second air flow conduit 275 are arranged at least partially in series. In other words, air flowing into at least a portion of the first air flow conduit 270 may have already passed through at least a portion of the second air flow conduit 275, or vice-versa. In one example, the first air flow conduit 270 and the second air flow conduit 275 are arranged entirely in series. In some examples, a portion of the first air flow conduit 270 is arranged in parallel with a portion of the second air flow conduit 275 and a further portion of the first air flow conduit 270 is arranged in series with a corresponding further portion of the second air flow conduit 275. In some examples, at least one of the first and the second air flow conduits 270, 275 is associated with a corresponding fan. The fan may be used to control the amount of air drawn into the corresponding air flow conduit from the shared air flow volume 220. In some examples, the amount of air drawn into a given air flow conduit from the shared air flow volume 220 is controlled by regulating the air pressure of the shared air flow volume 220.

In the present example, each of the first and the second air flow conduits 270, 275 delivers air 285, 290 to a common mixing region 280. The common mixing region 280 may form part of the shared air flow volume 220. In one example, the common mixing region 280 comprises at least one printer element. The at least one printer element may comprise, for example, a fusing lamp. Air 285 delivered to the common mixing region 280 via the first air flow conduit 270 may be mixed with air 290 delivered to the common mixing region 280 via the second air flow conduit 275. The air 285, 290 that is delivered to the common mixing region 280 by the first and the second air flow conduits 270, 275 may be air that has flowed across the corresponding internal printer components 230, 240. The common mixing region 280 may be external relative to at least one of the first and the second air flow conduits 270, 275. For example, the common mixing region 280 may be external to both the first and the second air flow conduits 270, 275. In some examples, the common mixing region 280 may be within the first air flow conduit 270. In other words, the second air flow conduit 275 may deliver air 290 into the first air flow conduit 270. In other examples, the common mixing region 280 may be within the second air flow conduit 275. In other words, the first air flow conduit 270 may deliver air 285 into the second air flow conduit 275. In some examples, the air pressure in the common mixing region 280 is controlled by regulating the air flow in the shared air flow volume 220, e.g. by controlling the speed of one or more inlet fans.

In the present example, the first internal printer component 230 is relatively hot compared with the second internal printer component 240. Therefore, the first internal printer component 230 may cause air 285 delivered to the common mixing region 280 by the first air flow conduit 270 to be relatively hot compared with air 290 delivered to the common mixing region 280 by the second air flow conduit 275. In some examples, there may be a negligible temperature difference between the first internal printer component 230 and the second internal printer component 240, but there may still be a temperature difference between air 285 delivered to the common mixing region 280 by the first air flow conduit 270 and air 290 delivered to the common mixing region 280 by the second air flow conduit 275. For example, the first air flow conduit 270 may comprise a greater number of internal printer components than the second air flow conduit 275. Therefore, air 285 delivered to the common mixing region 280 by the first air flow conduit 270 may be relatively hot compared with air 290 delivered to the common mixing region 280 by the second air flow conduit 275. The relative temperature difference between air 285 delivered to the common mixing region 280 by the first air flow conduit 270 and air 290 delivered to the common mixing region 280 by the second air flow conduit 275 is represented by shading of arrow 285 and no shading of arrow 290 in FIG. 2.

The common mixing region 280 may allow the relatively hot air 285 emanating from the first air flow conduit 270 to be cooled by the relatively cool air 290 emanating from the second air flow conduit 275. Consequently, components positioned downstream relative to the common mixing region 280 may be protected from the relatively hot air 285 and the potentially adverse effects arising from it, such as heat damage.

In the present example, the printer cooling apparatus 200 comprises a single air outlet 260. The single air outlet 260 may be arranged on or near the surface of the body of the 3D printer 210. In some examples, the single air outlet 260 is arranged within the body of the 3D printer 210. In other examples, the single air outlet 260 is arranged outside the body of the 3D printer 210. For example, the single air outlet 260 may be arranged as part of a hose or pipe extending outside the body of the 3D printer 210. The single air outlet 260 may be placed at a different location than the single air inlet 245. In some examples, the single air outlet 260 is arranged at a print zone or platen of the 3D printer 210. The single air outlet 260 may be arranged at a scan beam area of the 3D printer 210. The single air outlet 260 delivers air from the shared air flow volume 220 to the external surroundings of the 3D printer 210. In other words, the single air outlet 260 may provide an exhaust point for the printer cooling apparatus 200. In some examples, the single air outlet 260 delivers air from at least one of the first and the second air flow conduits 270, 275 to the exterior of the printer 210. In some examples, air is delivered from the common mixing region 280 via the single air outlet 260 to the external surrounds of the 3D printer 210. At least one outlet fan associated with the single air outlet 260 may be used to drive air out of the shared air flow volume 220. The at least one outlet fan may be controlled by control software. Such control software may be arranged within a computer control system comprising a processor and a memory. The computer control system may be arranged within the 3D printer 210 or within the printer cooling apparatus 200.

In the present example, the single air outlet 260 comprises a filter 265. The single air outlet 260 may comprise an outlet chamber. The filter 265 may be arranged within the outlet chamber. The filter 265 may filter air that is driven from the shared air flow volume 220. In some examples, the filter 265 filters air that is driven from at least one of the air flow conduits 270, 275. Air that is driven from at least one of the air flow conduits 270, 275 may comprise a suspension of powder or printing material. The powder or printing material may be collected from at least one of the internal printer components 230, 240. The filter 265 may filter air that is driven from the common mixing region 280. The filter 265 may be a particulate air filter. Filtering the air prior to egress from the printer cooling system 200 may protect the at least one outlet fan and/or other printer components from particles of dust, powder, dirt, printing material, etc.

The outlet filter 265 may be protected by the common mixing region 280 from potential damage arising from relatively hot air 285 flowing through the filter 265. Potential heat damage to at least one exhaust fan associated with the single air outlet 260 may be reduced through use of the common mixing region 280. The air pressure in the common mixing region 280 may be controlled in order to regulate the air flow through the single air outlet 260.

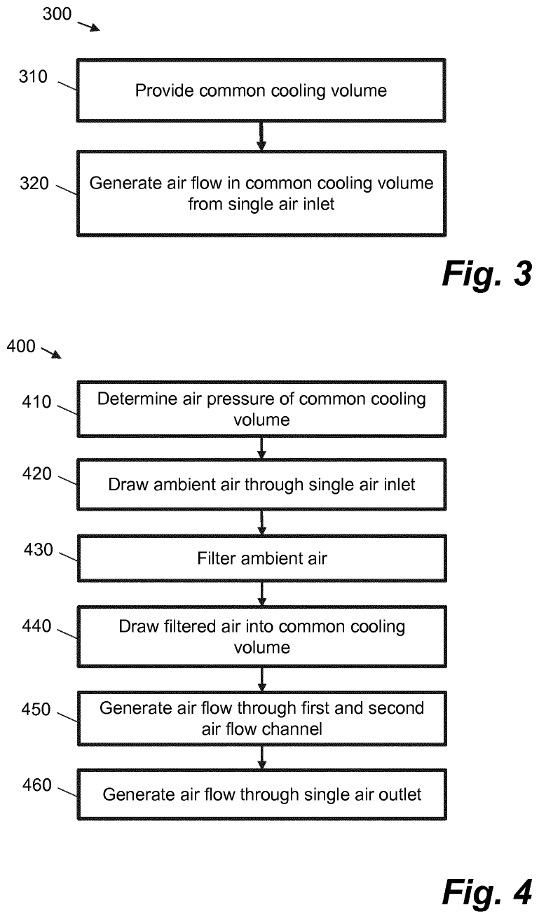

FIG. 3 shows a method 300 of operating a printer cooling system of an additive manufacturing system, the additive manufacturing system comprising a plurality of printer subsystems. The printer cooling system may comprise one of the printer cooling apparatuses 100 and 200 as previously described. The additive manufacturing system may be a 3D printer. The method 300 may be performed by a computer control system arranged in the additive manufacturing system or in the printer cooling system.

At block 310, a common cooling volume for cooling the plurality of printer subsystems is provided. The common cooling volume may act as a reservoir of cool air for conveying to each of the plurality of printer subsystems. The common cooling volume is coupled to a first air flow channel for cooling a first printer subsystem of the plurality of printer subsystems. The common cooling volume is coupled to a second air flow channel for cooling a second printer subsystem of the plurality of printer subsystems. The first and the second air flow channels may be arranged at least partially in parallel.

At block 320, an air flow is generated in the common cooling volume from a single air inlet to cool the plurality of printer subsystems.

FIG. 4 shows a method 400 of operating a printer cooling system of an additive manufacturing system, the additive manufacturing system comprising a plurality of printer subsystems. The printer cooling system may comprise one of the printer cooling apparatuses 100 and 200 as previously described. The additive manufacturing system may be a 3D printer. The printer cooling system comprises a common cooling volume for cooling the plurality of printer subsystems. The method 400 may be performed by a computer control system arranged in the additive manufacturing system or in the printer cooling system.

At block 410, an air pressure of the common cooling volume is determined. The air pressure of the common cooling volume may be measured by a pressure sensor arranged within or near the common cooling volume. The measured air pressure may then be transmitted to the computer control system of the additive manufacturing system or of the printer cooling system. The determined air pressure may be used to facilitate the generation of an air flow in the common cooling volume. In some examples, the determined air pressure is a trigger for generating such an air flow. In some examples, the air flow in the common cooling volume may be generated when the determined air pressure of the common cooling volume meets or exceeds a predetermined threshold value. In other examples, the air flow in the common cooling volume may be generated when the determined air pressure falls below a predetermined threshold value.

Air flow in the common cooling volume may be generated by activating at least one inlet fan. The at least one inlet fan may be controlled in a closed loop with the air pressure determination. In some examples, the pressure sensor determines whether the measured air pressure meets, exceeds or falls below a threshold value. In other examples, the computer control system determines whether the measured air pressure meets, exceeds or falls below the threshold value. In some examples, an existing air flow in the common cooling volume is controlled in accordance with the determined air pressure. An air flow in the common cooling volume may be increased and/or decreased in order to control an air pressure in the common cooling volume. For example, the air pressure in the common cooling volume may be kept relatively constant by altering the air flow into the common cooling volume. In some examples, controlling the air flow in the common cooling volume comprises increasing the air flow through the single air inlet, increasing the air flow in at least some of the air flow conduits, and/or increasing a release of excess air to the exterior of the additive manufacturing system.

The air temperature of the common volume may depend on the air flow in the common cooling volume. For example, a greater air flow in the common cooling volume may result in a lower air temperature in the common cooling volume. A lesser air flow in the common cooling volume may result in a higher air temperature in the common cooling volume. In some examples, the air flow in the common cooling volume can be controlled depending on the air temperature of the common cooling volume. In some examples, an air temperature of the common cooling volume is measured by a temperature sensor arranged within or near the common cooling volume. The measured air temperature may be transmitted to the computer control system to facilitate the generation of air flow in the common cooling volume. For example, air flow in the common cooling volume may be generated when the measured air temperature within the common cooling volume exceeds a predetermined threshold. In some examples, an existing air flow in the common cooling volume is controlled in accordance with the determined air temperature. For example, an air flow in the common cooling volume may be increased and/or decreased in order to maintain a relatively constant air temperature in the common cooling volume.

At block 420, ambient air is drawn from outside the additive manufacturing system through a single air inlet.

At block 430, the ambient air is filtered using a filter to produce filtered air, which is then drawn into the common cooling volume at block 440.

At block 450, an air flow is generated through a first and a second air flow channel from the common cooling volume. The first air flow channel is for cooling a first printer subsystem of the plurality of printer subsystems. The second air flow channel is for cooling a second printer subsystem of the plurality of printer subsystems. Each of the first and the second air flow channels is coupled to the common cooling volume. Consequently, the first air flow channel and the second air flow channel may be arranged in parallel. The air flow generated through the first and the second air flow channels from the common cooling volume cools the first and the second respective printer subsystems of the plurality of printer subsystems.

At block 460, an air flow is generated from the common cooling volume through a single air outlet. The single air outlet may enable an egress of air from the printer cooling system to be controlled. The single air outlet may comprise a filter. In some examples, air flow is generated from the first and the second air flow channel to a common mixing region. The common mixing region may enable relatively hot air emanating from one of the first and the second air flow channels to be cooled by relatively cool air emanating from the other of the first and the second air flow channels. Air flow may then be generated from the common mixing region through the single air outlet to the exterior of the additive manufacturing system. The air flow through the single air outlet may be controlled by altering the air pressure of the common mixing region. The air pressure of the common mixing region may be controlled by altering the air flow in the common cooling volume. In some examples, the air flow through the single air outlet is controlled by regulating the air pressure of the common cooling volume.

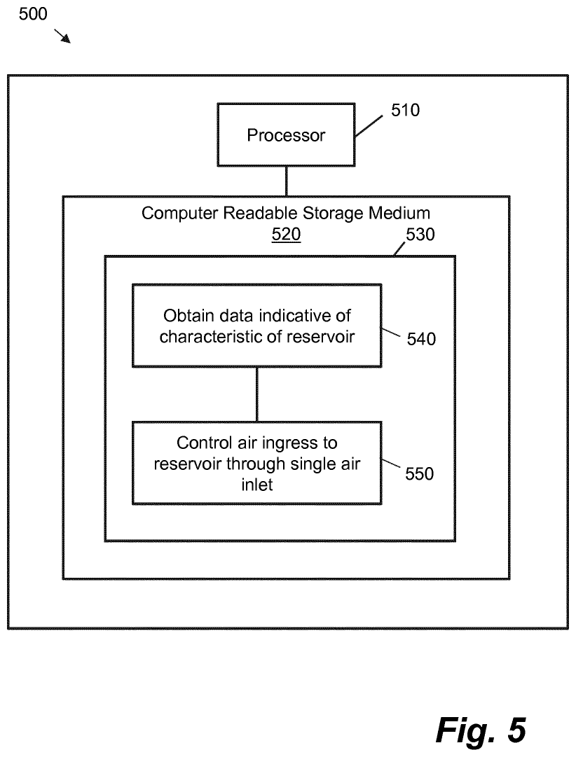

FIG. 5 shows example components of a printing system 500, which may be arranged to implement certain examples described herein. The printing system 500 may be an additive manufacturing system, commonly known as a 3D printer. A processor 510 (or processors) of the printing system 500 is coupled to a computer-readable storage medium 520 comprising a set of computer-readable instructions 530 stored thereon, which may be executed by the processor 510. The computer-readable instructions 530 instruct the processor 510 to perform a method of controlling a printer cooling system, the printer cooling system comprising a common air reservoir. Instruction 540 instructs the processor to obtain data indicative of a determined characteristic of the common air reservoir, the common air reservoir being arranged to cool a plurality of printer subsystems. The determined characteristic may be a pressure of the common air reservoir. In some examples, the determined characteristic is a temperature of the common air reservoir. Based on the obtained data, the processor 510 is instructed, via instruction 550, to control an ingress of air to the common air reservoir through a single air inlet. The single air inlet comprises a filter.

Processor 510 can include a microprocessor, microcontroller, processor module or subsystem, programmable integrated circuit, programmable gate array, or another control or computing device. The computer-readable storage medium 520 can be implemented as one or multiple computer-readable storage media. The computer-readable storage medium 520 includes different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. The computer-readable instructions 530 can be stored on one computer-readable storage medium, or alternatively, can be stored on multiple computer-readable storage media. The computer-readable storage medium 520 or media can be located either in the printing system 500 or located at a remote site from which computer-readable instructions can be downloaded over a network for execution by the processor 510.

Certain examples described herein relate to cooling apparatuses for printing systems. Other examples are envisaged in which cooling apparatuses are implemented in systems other than printing systems. In such other examples, a system has a plurality of subsystems that are cooled by air flow through a single air inlet into a common air flow volume.

The preceding description has been presented to illustrate and describe examples of the principles described. This description is not intended to be exhaustive or to limit these principles to any precise form disclosed. Many modifications and variations are possible in light of the above teaching.

What is claimed is:

1. A printer cooling apparatus of a three-dimensional printer, the printer cooling apparatus comprising:
a shared air flow volume for cooling a plurality of internal printer components, the shared air flow volume comprising:
a first air flow conduit for cooling at least a first internal printer component of the plurality of internal printer components; and
a second air flow conduit for cooling at least a second internal printer component of the plurality of internal printer components,
wherein the first air flow conduit and the second air flow conduit are arranged at least partially in parallel; and
a single air inlet to deliver ambient air from outside the three-dimensional printer to the shared air flow volume.

2. The printer cooling apparatus of claim 1, comprising at least one filter to filter the ambient air delivered to the shared air flow volume by the single air inlet.

3. The printer cooling apparatus of claim 1, comprising a single air outlet to deliver air from the shared air flow volume, the single air outlet comprising a filter.

4. The printer cooling apparatus of claim 1, comprising a pressure sensor to determine an air pressure of the shared air flow volume,
wherein the single air inlet delivers ambient air from outside the three-dimensional printer to the shared air flow volume based on the determined air pressure of the shared air flow volume.

5. The printer cooling apparatus of claim 1, wherein each of the first and the second air flow conduits delivers air to a common air mixing region.

6. The printer cooling apparatus of claim 5, wherein, during operation of the three-dimensional printer, the first internal printer component is relatively hot compared with the second internal printer component such that the first internal printer component causes air delivered to the common mixing region by the first air flow conduit to be relatively hot compared with air delivered to the common mixing region by the second air flow conduit.

7. The printer cooling apparatus of claim 5, wherein the first air flow conduit comprises a greater number of internal printer components than the second air flow conduit such that air delivered to the common mixing region by the first air flow conduit is relatively hot compared with air delivered to the common mixing region by the second air flow conduit.

8. The printer cooling apparatus of claim 1, wherein the plurality of internal printer components comprises at least one of a fusing lamp, a carriage, a blowing station and a service station.

9. A method of operating a printer cooling system of an additive manufacturing system, the additive manufacturing system comprising a plurality of printer subsystems, the method comprising:
providing a common cooling volume for cooling the plurality of printer subsystems, wherein the common cooling volume is coupled to a first air flow channel for cooling a first printer subsystem of the plurality of printer subsystems and wherein the common cooling volume is coupled to a second air flow channel for cooling a second printer subsystem of the plurality of printer subsystems; and
generating an air flow in the common cooling volume from a single air inlet to cool the plurality of printer subsystems.

10. The method of claim 9, comprising:
drawing ambient air from outside the additive manufacturing system through the single air inlet;
filtering the ambient air using a filter to produce filtered air; and
drawing the filtered air into the common cooling volume.

11. The method of claim 9, comprising generating an air flow from the common cooling volume through a single air outlet, wherein the single air outlet comprises a filter.

12. The method of claim 9, comprising:
determining an air pressure of the common cooling volume; and
generating the air flow in the common cooling volume based on the determined air pressure of the common cooling volume.

13. The method of claim 9, comprising generating air flow through the first and the second air flow channels from the common cooling volume to cool the first and the second respective printer subsystems of the plurality of printer subsystems.

14. A non-transitory computer-readable storage medium comprising a set of computer-readable instructions stored thereon, which, when executed by a processor, cause the processor to perform a method of controlling a printer cooling system comprising a common air reservoir, the method comprising:
obtaining data indicative of a determined characteristic of the common air reservoir, the common air reservoir being arranged to cool a plurality of printer subsystems; and
based on the obtained data, control an ingress of air to the common air reservoir through a single air inlet, wherein the single air inlet comprises a filter.

15. The non-transitory computer-readable storage medium of claim 14, wherein the determined characteristic comprises a pressure or a temperature of the common air reservoir.
